(19) United States
(12) Patent Application Publication
(10) Pub. No.: US 2025/0371169 A1
(43) Pub. Date: Dec. 4, 2025

(54) SYSTEM AND METHOD FOR PROVIDING PRIVACY-PRESERVING SEARCH SUGGESTIONS

(71) Applicants: Matt Wizeman, Leesburg, VA (US); Jeff Kunkle, Ashburn, VA (US)

(72) Inventors: Matt Wizeman, Leesburg, VA (US); Jeff Kunkle, Ashburn, VA (US)

(21) Appl. No.: 18/733,507

(22) Filed: Jun. 4, 2024

(51) Int. Cl. G06F 21/60; G06F 16/9532

(52) U.S. Cl. CPC G06F 21/60; G06F 16/9532

(57) ABSTRACT

A system and method for providing privacy-preserving search suggestions is disclosed. The system receives a plurality of documents having text content and generates at least one first word embedding for each document. The system further generates a list of first search phrases for each document using Large Language Models (LLMs), and generates at least one second word embedding for each first search phrase. Further, each first word embedding is compared to the corresponding second word embedding to rank the first search phrases based on similarity to the documents. The system is configured to deduplicate one or more ranked search phrases having a rank lower than a first predefined rank, and execute remaining ranked search phrases after deduplication in a search engine to evaluate search results and determine final search phrases from the remaining ranked search phrases based on the search results.

### BACKGROUND OF THE INVENTION

Conventional search engines provide useful search suggestions that help users understand search topics and query formatting. The search suggestion further assists users to expedite the process of finding relevant results by guiding users to more precise and accurate search queries. Generally, the search engine operates by recording and processing past searches performed by users and provides search suggestions, without consideration for the content of those search strings. Although additional contextual factors like time and location may be incorporated, the approach of the search engine primarily revolves around past search data.

However, this method poses several problems. One problem involves the risk of exposing sensitive information, such as specific query strings entered by one user being suggested to another user. Another problem involves the exposure of interest between different user communities. This occurs when a collection of searches from one user community exposes topics or areas of interest through suggested searches that are visible to a different user community. The search suggestion may expose potentially sensitive information about users' preferences, behaviors, or inclinations to individuals who are not directly associated with the original community and may lead to potential privacy breaches and compromises.

Therefore, there is a need for a system and method for providing search suggestions without using past search information. The system and method further need to provide highly accurate, context-relevant search suggestions without using any user-provided information.

### SUMMARY OF THE INVENTION

The present invention discloses a system and method for providing privacy-preserving search suggestions. The system comprises at least one computing device comprising at least one storage device for storing one or more program modules. The program modules are executed by the computing device to perform one or more operations for providing privacy-preserving search suggestions. The computing device is configured to receive an input data comprising a plurality of documents having text content. The computing device is configured to generate at least one first word embedding for each document. The computing device is further configured to generate a list of first search phrases for each document using Large Language Models (LLMs). The computing device is further configured to generate at least one second word embedding for each first search phrase.

The computing device is further configured to compare each first word embedding to the corresponding second word embedding to rank the first search phrases based on similarity to the documents and create a plurality of ranked search phrases for each document. The plurality of ranked search phrases is an arrangement of first search phrases in an order based on similarity to the documents. The computing device is further configured to deduplicate one or more ranked search phrases having a rank lower than a first predefined rank. The deduplication involves conducting pair-wise comparisons of the embeddings associated with each search phrase to determine conceptual duplicates. The computing device is further configured to execute remaining ranked search phrases after deduplication in a search engine to evaluate search results and determine a set of final search phrases from the remaining ranked search phrases based on the search results. The computing device is further configured to refine the set of final search phrases by providing a set of final search phrases having a rank higher than a second predefined rank.

In one embodiment, a method for providing privacy-preserving search suggestions is disclosed. The method is executed in a system comprising at least one computing device comprising at least one storage device for storing one or more program modules. The program modules are executed by the computing device to perform one or more operations. At one step, an input data comprising a plurality of documents having text content is received. At another step, each document is fed into one or more Large Language Models (LLMs) executed at the computing device. At yet another step, a list of first search phrases is generated for each document using Large Language Models (LLMs). At yet another step, the list of first search phrases is filtered based on similarity to the documents to provide a set of final search phrases. The plurality of ranked search phrases is an arrangement of first search phrases in an order based on similarity to the documents.

In another embodiment, a method for providing privacy-preserving search suggestions is disclosed. The method is executed in a system comprising at least one computing device comprising at least one storage device for storing one or more program modules. The program modules are executed by the computing device to perform one or more operations. At one step, an input data comprising a plurality of documents having text content is received. At another step, each document is fed into one or more Large Language Models (LLMs) executed at the computing device. At yet another step, a list of first search phrases is generated for each document using Large Language Models (LLMs). The plurality of ranked search phrases is an arrangement of first search phrases in an order based on similarity to the documents. At yet another step, at least one second word embedding is generated for each first search phrase. At yet another step, each first word embedding is compared to the corresponding second word embedding to rank the first search phrases based on similarity to the documents and create a plurality of ranked search phrases for each document. At yet another step, one or more ranked search phrases having a rank lower than a first predefined rank are deduplicated. The deduplication involves conducting pair-wise comparisons of the embeddings associated with each search phrase to determine conceptual duplicates.

At yet another step, the remaining ranked search phrases after deduplication are executed in a search engine to evaluate search results and determine a set of final search phrases from the remaining ranked search phrases based on the search results. At yet another step, the set of final search phrases is refined by providing a set of final search phrases having a rank higher than a second predefined rank.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

FIG. 1 exemplarily illustrates an environment of a system for providing privacy-preserving search suggestions, according to an embodiment of the present invention.

FIG. 2 exemplarily illustrates a flowchart of a method for providing privacy-preserving search suggestions, according to an embodiment of the present invention.

### DETAILED DESCRIPTION

A description of embodiments of the present disclosure will now be given with reference to the figures. It is expected that the present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes that come within the meaning and range of equivalency of the claims are to be embraced within their scope.

Before any embodiments of the invention are explained in detail, it is to be understood that the disclosure is not limited in its application to the details of construction nor to the arrangement of components set forth in the following description or illustrated in the drawings. The disclosure is capable of other embodiments and of being practiced or of being carried out in various ways.

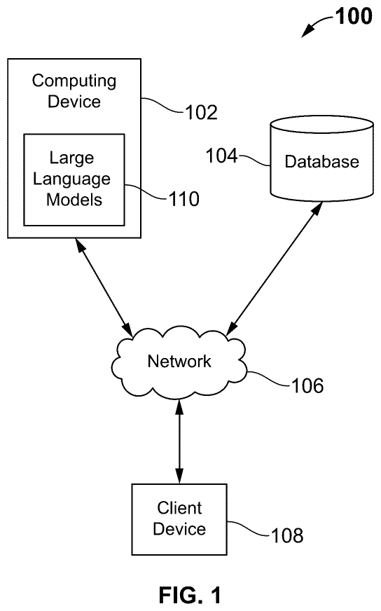

FIG. 1 exemplarily illustrates an environment 100 of a system for providing privacy-preserving search suggestions, according to an embodiment of the present invention. The system is configured to provide a highly accurate, context-relevant search suggestions without using any user-provided information. The system comprises at least one computing device 102 and at least one database 104 in communication with the computing device 102 via a network 106. The system further comprises one or more Large Language Models (LLM) 110 to provide search suggestion functionality without using search information of any users. The system further comprises one or more client devices 108 in communication with the computing device 102 via the network 106.

The client device 108 is associated with a user. The client device 108 includes, but not limited to, a desktop computer, a laptop computer, a mobile phone, a personal digital assistant, and the like. The client device 108 is configured to execute one or more client applications such as, without limitation, a web browser to access and view content over the network 106, and a File Transfer Protocol (FTP) client for file transfer. The client device 108 in various embodiments, may include a Wireless Application Protocol (WAP) browser or other wireless or mobile device protocol suites.

The network 106 generally represents one or more interconnected networks, over which the computing device 102 and the client device 108 could communicate with each other. The network 106 may include packet-based wide area networks (such as the Internet), local area networks (LAN), private networks, wireless networks, satellite networks, cellular networks, paging networks, and the like. A person skilled in the art will recognize that the network 106 may also be a combination of more than one type of network. For example, the network 106 may be a combination of a LAN and the Internet. In addition, the network 106 may be implemented as a wired network or a wireless network or a combination thereof.

The system further comprises at least one database 104 in communication with the computing device 102. In an example, the database 104 resides in the computing device 102. In another example, the database 104 resides separately from the computing device 102. Regardless of the location, the database 104 comprises a memory to store and organize data for use by the computing device 102. The database 104 comprises information for use by the computing device 102 to provide privacy-preserving search suggestions.

In one embodiment, the computing device 102 is at least one of a server, a general-purpose computer, a special-purpose computer, a workstation, a desktop, a laptop, a tablet, a mobile phone, a mainframe, a supercomputer and a server farm. Although the computing device 102 is illustrated as a single device, the functions performed by the computing device 102 could be performed using any suitable number of computing devices 102. The computing device 102 comprises at least one memory configured to store a set of program modules and at least one processor. The processor is configured to execute the modules to perform one or more operations of the system. The computing device 102 further comprises large language models (LLM) 110 and post-processing modules. It should be understood that Large Language Models 110 are capable of operation without necessity for local execution on a controlled computing device 102, as they may be activated through an Application Programming Interface (API) on a managed service.

The computing device 102 is configured to receive input data comprising text-based content. In one embodiment, the input data comprises a plurality of documents comprising text-based content. The computing device 102 is further configured to generate at least one first word embedding for each document. The first word embedding is a representation of a word, a phrase, a paragraph, or the entire document text. The first word embedding is a representation of a real-valued vector encoding the semantic meanings of the respective words, phrases, paragraphs, or document. The vector representation is structured such that words positioned closer within the vector space are anticipated to share similarities in meaning. Additionally, the computing device 102 is configured to employ document embeddings to facilitate expedited conceptual evaluations in contrast to suggested search strings.

The computing device 102 is further configured to feed each document to be searched into one or more Large Language Models (LLM) 110. The LLM prompt instructs the LLM 110 to generate a list of first search phrases to effectively search for the document. The search phrases are in a format for use by the user. The prompts utilized are customized to suit the specific content domain, intended use case, and the search technology being utilized.

The first search phrases could be used by users to effectively search for documents. Optionally, the computing device 102 is configured to filter first search phrases to provide a set of final search phrases that could provide better results. The filtering process is explained detailly as follows.

The computing device 102 is further configured to generate at least one second word embedding for each search phrase. The second word embedding is a representation of a word or a phrase. The second word embedding is a representation of a real-valued vector encoding the semantic meanings of the respective words or phrases. The vector representation is structured such that words positioned closer within the vector space are anticipated to share similarities in meaning.

The computing device 102 is further configured to create a plurality of ranked search phrases for each document. The ranked search phrases are created by comparing each first word embedding to the corresponding second word embedding and ranking the search phrases based on similarity to the texts in the documents. Subsequently, the search phrases are to be arranged in a ranked order, ranging from the most similar phrases to the least similar phrases with respect to the document. This ranking is used as the basis for determining the search suggestions to be retained and for determining the search suggestion to be discarded during subsequent processing stages.

The computing device 102 is further configured to deduplicate one or more ranked search phrases having a rank lower than a first predefined rank. A proportion of ranked search phrases generated by Large Language Models (LLMs) 110 are prone to duplication, particularly when multiple LLMs 110 are employed to generate the list of candidate suggestions.

They could be word-for-word duplicates or simple variations in word order as two examples. A pair-wise comparison of the embeddings for each suggestion can be used to eliminate conceptual duplicates. The specific similarity percentage used to indicate duplicates is obtained through experimentation with the target content. If duplicates are detected, the lower-ranked search phrase is removed.

The computing device 102 is further configured to execute the remaining ranked search phrases after deduplication in a search engine to evaluate search results and determine a set of final search phrases from the remaining ranked search phrases based on the search results. As every search suggestion generated by LLM 110 may not return the intended results, this step's evaluation step is important to determine the final search phrases that are the best performing suggestions. The evaluation step is performed by an implementer or the user. As an example, a simple evaluation could keep any suggestion that results in the target document being one of the first five results returned by the search engine.

After executing the filtering processes described above, the number of remaining search suggestions may be more than a desired number of search suggestions. In such cases, implementers could use the top N remaining suggestions from the rankings of first search phrases. The computing device 102 is further configured to provide the set of final search phrases having a rank higher than a second predefined rank. The set of final search phrases is the top N remaining suggestions from the rankings of first search phrases.

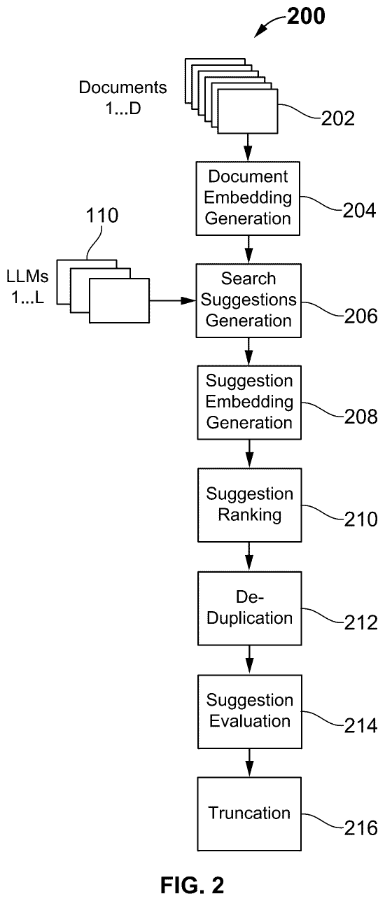

FIG. 2 exemplarily illustrates a flowchart 200 of a method for providing privacy-preserving search suggestions, according to an embodiment of the present invention. The method is executed in a system comprising at least one computing device 102 comprising at least one storage device for storing one or more program modules. The program modules are executed by the computing device 102 to perform one or more operations. The computing device 102 further comprises large language models (LLM) 110 and post-processing modules.

At step 202, the input data is received at the computing device 102. The input data is a text-based content. In one embodiment, the input data comprises a plurality of documents comprising text-based content. In one embodiment, the input data is received via an automated bulk data processing method.

At step 204, the method enables document embedding generation. The document embedding generation involves generating at least one first word embedding E (D) for each document D. A word embedding is a representation of a word, a phrase, a paragraph, or the entire document text. Typically, the representation is a real-valued vector that encodes the input's meaning so that inputs containing words closer in the vector space are expected to be similar in meaning. Further, document embeddings facilitate expedited conceptual evaluations in contrast to suggested search strings.

At step 206, the method enables search suggestion generation. The search suggestion generation involves feeding each document into one or more large language models (LLM) 110. The computing device 102 generates a list of first search phrases that could be used to effectively search for the document. For each document D, 1 . . . . N suggestions are generated using each LLM 110 in L, for a total set of D×L×N suggestions, S, per document D.

At step 208, the method enables suggestion embedding generation. For each suggestion in S, a corresponding second word embedding, E(S) is generated.

At step 210, the method enables suggestion ranking. The suggestion ranking involves comparing each second word embedding, E(S), to the corresponding first word embedding, E (D). The results are ranked from most similar to least, creating a ranked set of suggestions, R(S) or ranked search phrases.

At step 212, the method performs de-duplication of search phrases. The deduplication step involves comparing each pair of suggestion embeddings in E(S), and removing the lower ranked suggestion from R(S) for any pairs where the similarity exceeds X %, where X is chosen through iterative trial and error.

At step 214, the method performs suggestion evaluation of search phrases. For each suggestion remaining in R(S), a search is executed against the search engine, keeping only those suggestions where the Document D ranks higher than the Nth result, where N is chosen through iterative trial and error.

At step 216, the method enables truncation of the search phrase list. For a desired number of search suggestions per document, N, only the top N ranked results of R(S) are retained when the number of suggestions in R(S)>N.

Advantageously, the present invention leverages Large Language Models (LLMs) 110 and a post-processing algorithm to generate high-quality search suggestions for any type of text-based content, without using any user-provided information. The present invention is particularly advantageous in environments where search strings may contain personal or sensitive information, such as in government organizations or highly regulated industries.

Further, leveraging the LLM 110 driven process described above, the invention delivers all the traditional benefits associated with suggested searches without using any user information, ensuring total privacy of the information contained in user search strings. Additionally, the amount of computing power required by the present invention is comparable to existing solutions that leverage the contents of user search strings. The present invention further enables to apply autocompleting search suggestion feature to search engine without leveraging any historical user search history, ensuring complete privacy of user-provided information.

The system enhances the user experience by providing several benefits and is described as follows. The system helps in query formulation by providing relevant search phrases. The system enables users to discover new concepts or alternative search string from the search suggestions. The system reduces the user's effort by predicting and suggesting complete queries. The system is mobile friendly as the autocomplete feature simplifies search entry on mobile devices. The system refines the queries of the user, which provides educational insight to the user.

The present invention could be applied to any search implementation that proactively provides search suggestions. The present invention further could be applied to commercial products or in-house developed capabilities. The present invention is particularly valuable in situations where user privacy is important or regulated in any scenario of modern-day computing.

The foregoing description comprises illustrative embodiments of the present disclosure. Having thus described exemplary embodiments of the present disclosure, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method.

Many modifications and other embodiments of the disclosure will come to mind to one skilled in the art to which this disclosure pertains having the benefit of the teachings presented in the foregoing descriptions. Although specific terms may be employed herein, they are used only in generic and descriptive sense and not for purposes of limitation. Accordingly, the present disclosure is not limited to the specific embodiments illustrated herein. While the above is a complete description of the preferred embodiments of the disclosure, various alternatives, modifications, and equivalents may be used. Therefore, the above description and the examples should not be taken as limiting the scope of the disclosure, which is defined by the appended claims.

1. A system for providing privacy-preserving search suggestions, comprising:
at least one computing device comprising at least one storage device for storing one or more program modules, wherein the computing device comprises Large Language Models (LLMs), wherein the program modules executed by the computing device causes the computing device to:
receive an input data comprising a plurality of documents having text content;
generate at least one first word embedding for each document;
generate a list of first search phrases for each document using Large Language Models;
generate at least one second word embedding for each first search phrase;
compare each first word embedding to the corresponding second word embedding to rank the first search phrases based on similarity to the documents and create a plurality of ranked search phrases for each document;
deduplicate one or more ranked search phrases having a rank lower than a first predefined rank, and
execute remaining ranked search phrases after deduplication in a search engine to evaluate search results and determine a set of final search phrases from the remaining ranked search phrases based on the search results.

2. The system of claim 1, wherein the computing device is further configured to refine the set of final search phrases by providing a set of final search phrases having a rank higher than a second predefined rank.

3. The system of claim 1, wherein the plurality of ranked search phrases is an arrangement of first search phrases in an order based on similarity to the documents.

4. The system of claim 1, wherein the deduplication involves conducting pair-wise comparisons of the embeddings associated with each search phrase to determine conceptual duplicates.

5. A method for providing privacy-preserving search suggestions executed in a system comprising at least one computing device comprising at least one storage device for storing one or more program modules, wherein the program modules are executed by the computing device to perform one or more operations, wherein the method comprising the steps of:
receiving an input data comprising a plurality of documents having text content;
feeding each document into one or more Large Language Models (LLMs) executed at the computing device;
generate a list of first search phrases for each document using Large Language Models (LLMs), and
filtering the list of first search phrases based on similarity to the documents and providing a set of final search phrases.

6. The method of claim 5, wherein the step of filtering further comprising the steps of:
generating at least one first word embedding for each document;
generating at least one second word embedding for each first search phrase;
comparing each first word embedding to the corresponding second word embedding to rank the first search phrases based on similarity to the documents and creating a plurality of ranked search phrases for each document;
deduplicating one or more ranked search phrases having a rank lower than a first predefined rank, and
executing remaining ranked search phrases after deduplication in a search engine to evaluate search results and determining a set of final search phrases from the remaining ranked search phrases based on the search results.

7. The method of claim 6, further comprising a step of: refining the set of final search phrases by providing a set of final search phrases having a rank higher than a second predefined rank.

8. The method of claim 6, wherein the plurality of ranked search phrases is an arrangement of first search phrases in an order based on similarity to the documents.

9. The method of claim 6, wherein the deduplication involves conducting pair-wise comparisons of the embeddings associated with each search phrase to determine conceptual duplicates.

10. A method for providing privacy-preserving search suggestions executed in a system comprising at least one computing device comprising at least one storage device for storing one or more program modules, wherein the program modules are executed by the computing device to perform one or more operations, wherein the method comprising the steps of:
receiving an input data comprising a plurality of documents having text content;
generating at least one first word embedding for each document;
generating a list of first search phrases for each document using Large Language Models (LLMs) executed at the computing device;
generating at least one second word embedding for each first search phrase;
comparing each first word embedding to the corresponding second word embedding to rank the first search phrases based on similarity to the documents and creating a plurality of ranked search phrases for each document;
deduplicating one or more ranked search phrases having a rank lower than a first predefined rank, and
executing remaining ranked search phrases after deduplication in a search engine to evaluate search results and determining a set of final search phrases from the remaining ranked search phrases based on the search results.

11. The method of claim 10, further comprising a step of: refining the set of final search phrases by providing a set of final search phrases having a rank higher than a second predefined rank.

12. The method of claim 10, wherein the plurality of ranked search phrases is an arrangement of first search phrases in an order based on similarity to the documents.

13. The method of claim 10, wherein the deduplication involves conducting pair-wise comparisons of the embeddings associated with each search phrase to determine conceptual duplicates.
